(19) United States
(12) Patent Application Publication
(10) Pub. No.: US 2024/0424925 A1
(43) Pub. Date: Dec. 26, 2024

(54) CHARGING TERMINAL FOR A CHARGING INLET ASSEMBLY OF A VEHICLE

(71) Applicant: TE Connectivity Solutions GmbH, Schaffhausen (CH)

(72) Inventor: Joel Plasencia, Winston Salem, NC (US)

(21) Appl. No.: 18/739,511

(22) Filed: Jun. 11, 2024

Related U.S. Application Data
(60) Provisional application No. 63/644,582, filed on May 9, 2024.
(60) Provisional application No. 63/522,484, filed on Jun. 22, 2023.

(51) Int. Cl. B60L 53/16; H01R 4/22

(52) U.S. Cl. CPC B60L 53/16; H01R 4/22

(57) ABSTRACT

A charging inlet assembly includes a charging inlet housing that has a front and a rear. The charging inlet housing has terminal channels between the front and the rear. The charging inlet assembly includes charging terminals received in the corresponding terminal channels and held in the charging inlet housing. The charging terminals have mating ends and terminating ends. The terminating ends configured to be electrically coupled to corresponding power cables. The mating ends include pins configured to be connected to a charging plug. The pins extend to distal ends. The charging inlet assembly includes terminal caps coupled to the corresponding pins. The terminal caps are manufactured from a dielectric material. The terminal caps are threadably coupled to the distal ends.

### CROSS REFERENCE TO RELATED APPLICATIONS

This application claims benefit to US application No. U.S. Application No. 63/644,582, filed 9 May 2024, titled “CHARGING TERMINAL FOR A CHARGING INLET ASSEMBLY OF A VEHICLE” and 63/522,484, filed 22 Jun. 2023, titled “SERVICEABLE/ARC-SAFE FINGER PROTECTION CAP” the subject matter of which are herein incorporated by reference in their entirety.

### BACKGROUND OF THE INVENTION

The subject matter herein relates generally to vehicle charging systems.

Charging inlet assemblies are used to charge vehicles, such as for charging a battery system of an electric vehicle (EV) or hybrid electric vehicle (HEV). The charging inlet assembly includes charging terminals held by a housing of the charging inlet assembly. The charging terminals include finger protection caps at the ends of the charging terminals to prevent inadvertent touching of the charging terminal. However, the finger protection caps are susceptible to damage, such as from electrical acing during charging. Repair or replacement of the finger protection cap is difficult and typically requires removal of the entire charging inlet assembly for replacement of the charging terminal. Additionally, the finger protection caps may inadvertently pop off of the charging terminal and become lodged in the charging plug.

A need remains for an improved charging inlet assembly.

### BRIEF DESCRIPTION OF THE INVENTION

In one embodiment, a charging inlet assembly is provided and includes a charging inlet housing that has a front and a rear. The charging inlet housing has terminal channels between the front and the rear. The charging inlet assembly includes charging terminals received in the corresponding terminal channels and held in the charging inlet housing. The charging terminals have mating ends and terminating ends. The terminating ends configured to be electrically coupled to corresponding power cables. The mating ends include pins configured to be connected to a charging plug. The pins extend to distal ends. The charging inlet assembly includes terminal caps coupled to the corresponding pins. The terminal caps are manufactured from a dielectric material. The terminal caps are threadably coupled to the distal ends.

In another embodiment, a charging terminal for a charging inlet assembly is provided. The charging terminal includes a terminal body extending between a front and a rear. The terminal body include a mounting portion configured to be secured in a terminal channel of the charging inlet assembly. The charging terminal includes a terminating portion at the rear. The terminating portion configured to be terminated to a power cable. The charging terminal includes a mating portion at the front. The mating portion includes a pin configured to be connected to a charging socket of a charging plug. The pin has a distal end. The charging terminal includes a terminal cap threadably coupled to the distal end of the pin. The terminal cap is manufactured from a dielectric material.

In a further embodiment, a charging terminal for a charging inlet assembly is provided. The charging terminal includes a terminal body that extend between a front and a rear. The terminal body include a mounting portion configured to be secured in a terminal channel of the charging inlet assembly. The charging terminal includes a terminating portion at the rear. The terminating portion configured to be terminated to a power cable. The charging terminal includes a mating portion at the front. The mating portion includes a pin configured to be connected to a charging socket of a charging plug. The pin has a distal end. The pin has a threaded bore open at the distal end. The charging terminal includes a terminal cap coupled to the pin. The terminal cap is manufactured from a dielectric material. The terminal cap includes a tip and a threaded shaft extend from the tip. The threaded shaft is threadably coupled to the threaded bore. The tip is located forward of the distal end.

### BRIEF DESCRIPTION OF THE DRAWINGS

FIG. 1 is a front perspective view of a charging inlet assembly in accordance with an exemplary embodiment.

FIG. 2 is a rear perspective view of the charging inlet assembly in accordance with an exemplary embodiment.

FIG. 3 is an exploded view of the DC charging terminal in accordance with an exemplary embodiment.

FIG. 4 is an assembled view of the DC charging terminal in accordance with an exemplary embodiment.

### DETAILED DESCRIPTION OF THE INVENTION

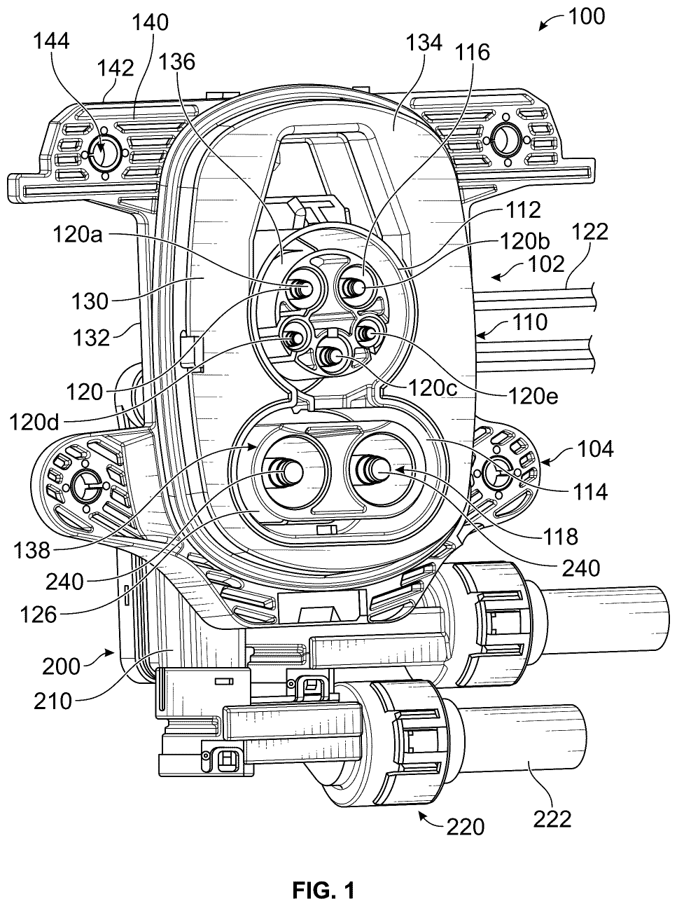

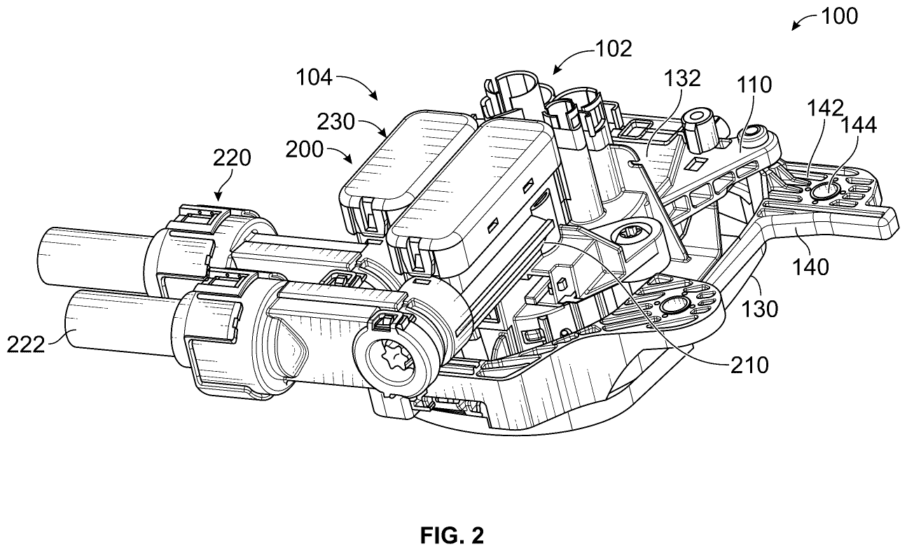

FIG. 1 is a front perspective view of a charging inlet assembly 100 in accordance with an exemplary embodiment. FIG. 2 is a rear perspective view of the charging inlet assembly 100 in accordance with an exemplary embodiment. The charging inlet assembly 100 includes an AC charging module 102 and a DC charging module 104 in accordance with an exemplary embodiment.

The charging inlet assembly 100 is used as a charging inlet for a vehicle, such as an electric vehicle (EV) or hybrid electric vehicle (HEV). The charging inlet assembly 100 is configured for mating reception with a charging connector (not shown). In an exemplary embodiment, the charging inlet assembly 100 is configured for mating with various types of charging connectors, such as a DC fast charging connector (for example, the SAE combo CCS charging connector) in addition to AC charging connectors (for example, the SAE J1772 charging connector). The charging inlet assembly 100 may be charging connectors associated with North American Charging System (NACS), such as SAE J3400 charging connectors.

The charging inlet assembly 100 includes a housing 110 configured to be mounted in the vehicle. The housing 110 holds the AC charging module 102 and the DC charging module 104 for mating with the charging connector. In various embodiments, components of the AC charging module 102 and/or the DC charging module 104 are removable from the housing 110. For example, the charging modules 102, 104 may be coupled to the housing 110 using latches, fasteners, clips, or other securing means. The charging modules 102, 104 may be removable from the housing 110 to separate components of the charging modules 102, 104 (for example, charging pins, cables, circuit boards, and the like) from the housing 110, such as for repair and/or replacement of the charging module components or other components of the charging inlet assembly 100.

In an exemplary embodiment, the housing 110 includes an AC section 112 that receives the AC charging module 102 and a DC section 114 that receives the DC charging module 104. The AC section 112 is configured for mating with an AC charging connector or an AC section of the charging connector. The DC section 114 is configured for mating with a DC charging connector or a DC section of the charging connector. The AC section 112 includes AC terminal channels 116. The DC section 114 includes DC terminal channels 118.

The AC charging module 102 includes AC terminals 120 at the AC section 112. The AC terminals 120 are held in the housing 110. The AC terminals 120 are received in corresponding AC terminal channels 116. The AC terminals 120 are configured to be mated to the charging connector. In the illustrated embodiment, five AC terminals 120 are provided, including a first AC charging terminal 120a, a second AC charging terminal 120b, a ground terminal 120c, a proximity terminal 120d, and a pilot terminal 120e. Optionally, the AC terminals 120 may be different sized terminals. In an exemplary embodiment, the AC terminals 120 include pins at mating ends of the AC terminals 120. AC cables 122 are terminated to the AC terminals 120 and extend from the charging inlet assembly 100 to another component of the vehicle, such as the battery system of the vehicle. In various embodiments, the AC cables 122 may extend straight away from the AC charging module 102 and housing 110. In other various embodiments, the AC cables 122 may extend away from the AC charging module 102 and housing 110 at 90° (for example, right angle) or at other angles.

In an exemplary embodiment, the AC section 112 of the charging inlet assembly 100 defines a low-voltage connector configured to be coupled to the low-voltage portion of the charging connectors. The low-voltage connector (for example, the AC terminals 120 and the AC cables 122) is configured to be coupled to other components in the system, such as a battery distribution unit, to control charging of the vehicle. The low-voltage connector may transmit/receive signals relating to charging, such as status of connection, status of charge, voltage of charge, and the like. The low-voltage connector may be a socket connector configured to receive the charging plug. Seals may be provided at the interface of the low-voltage connector.

The DC charging module 104 includes a DC charging port 126 at the front of the housing 110 configured for mating with the charging plug, a DC terminal module 200 at the rear of the housing 110, and a DC cable assembly 220 configured to be removable coupled to the DC terminal module 200. The DC terminal module 200 includes a DC housing 210, one or more DC terminals 240, and one or more cover assemblies 230 coupled to the DC housing 210 to cover the DC terminals 240. The DC housing 210 is coupled to the rear of the inlet housing 110. The DC terminals 240 pass through the inlet housing 110 to the front of the inlet housing 110 at the DC charging port 126 for mating with the charging connector. The DC cable assembly 220 includes DC power cables 222 electrically coupled to the corresponding DC terminals 240.

When assembled, the DC terminals 240 are arranged at the DC section 114. The DC terminals 240 are arranged in the housing 110 at the DC charging port 126. The DC terminals 240 are received in corresponding DC terminal channels 118. The DC terminals 240 are configured to be mated to the charging connector. In the illustrated embodiment, two DC terminals 240 are provided. In an exemplary embodiment, the DC terminals 240 include pins at mating ends of the DC terminals 240. The DC power cables 222 extend from the charging inlet assembly 100 to another component of the vehicle, such as the battery system of the vehicle. In various embodiments, the DC power cables 222 may extend away from the DC terminal module 200 at 90° (for example, right angle) or at other angles.

In an exemplary embodiment, the DC section 114 of the charging inlet assembly 100 defines a high-voltage connector configured to be coupled to the high-voltage portion of the charging connector. The high-voltage connector (for example, the DC terminals 240 and the DC power cables 222) is configured to be coupled to other components in the system, such as the battery and/or the battery distribution unit of the vehicle. The high-voltage connector is used for fast charging of the battery. The high-voltage connector may be a socket connector configured to receive the charging plug. Seals may be provided at the interface of the high-voltage connector.

The inlet housing 110 includes a front 130 and a rear 132. The front 130 of the housing 110 faces outward and is presented to the operator to connect the charging connector. The rear 132 faces the interior of the vehicle and is generally inaccessible without removing the housing 110 from the vehicle. The housing 110 includes a panel 134 at the front 130. In an exemplary embodiment, an AC socket 136 is formed in the panel 134 at the AC section 112 and a DC socket 138 is formed in the panel 134 at the DC section 114. The AC socket 136 incudes a space around the AC terminals 120 that receives the charging connector. During charging, the AC charging connector is plugged into the AC socket 136 to electrically connect to the AC terminals 120. The DC socket 138 includes a space around the DC terminals 240 that receive the charging connector. The DC charging connector is configured to be plugged into the DC socket 138. During charging, the DC charging connector is plugged into the DC socket 138 to electrically connect to the DC terminals 240. The panel 134 may surround the AC socket 136 and the DC socket 138 at the front 130.

In an exemplary embodiment, the housing 110 includes a mounting flange 140 (FIG. 1) coupled to the panel 134 at the front 130. The mounting flange 140 includes mounting tabs 142 used for mounting the housing 110 to the vehicle. The mounting tabs 142 having openings 144 that receive fasteners (not shown) to secure the charging inlet assembly 100 to the vehicle. Other types of mounting features may be used to secure the charging inlet assembly 100 to the vehicle. The housing 110 and/or the mounting flange may include a seal to seal the charging inlet assembly 100 to the vehicle.

In various embodiments, the charging inlet assembly 100 may include a terminal cover (not shown) at the front of the housing 110 to cover portions of the housing 110, such as the DC section 114 and/or the AC section 112. The housing 110 may include one or more rear covers at the rear of the housing 110 to close access to the rear of the housing 110. The cover(s) may be clipped or latched onto the main part of the housing 110, such as using clips or latches. Other types of securing features, such as fasteners may be used in alternative embodiments.

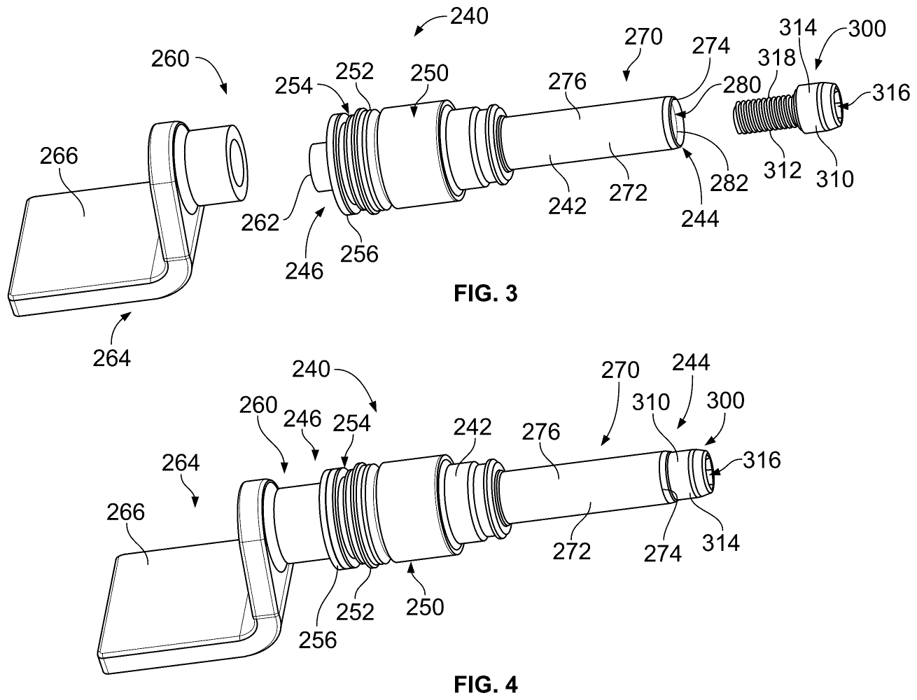

FIG. 3 is an exploded view of the DC charging terminal 240 in accordance with an exemplary embodiment. FIG. 4 is an assembled view of the DC charging terminal 240 in accordance with an exemplary embodiment. The AC charging terminals 120 (shown in FIG. 1) may be similar to the DC charging terminal 240 and include similar components.

The charging terminal 240 includes a terminal body 242 extending between a front 244 and a rear 246. The charging terminal 240 includes a mounting portion 250 configured to be secured in the terminal channel 118, such as in the inlet housing 110 and/or the DC housing 210 (shown in FIG. 2). The charging terminal 240 includes a terminating portion 260 at the rear 246 configured to be terminated to the DC power cable 222. The charging terminal 240 includes a mating portion 270 at the front 244 configured to be connected to the corresponding charging socket of the charging plug.

The charging terminal 240 includes cylindrical portions. For example, the mounting portion 250 may be a cylindrical portion. In an exemplary embodiment, the mounting portion 250 includes a terminal seal 252 configured to be sealed between the charging terminal 240 and the housing 110. The terminal seal 252 extend circumferentially around the mounting portion 250. In an exemplary embodiment, the mounting portion 250 includes a groove 254 extending circumferentially around the mounting portion 250. The groove 254 is configured to receive a latch or other securing element to secure the charging terminal 240 in the housing 110. The mounting portion 250 includes one or more flanges 256.

In an exemplary embodiment, the charging terminal 240 includes a post 262 at the rear 246. The terminating portion 260 includes a terminal busbar 264 coupled to the post 262. The terminal busbar 264 may be secured to the post 262 by welding. In other embodiments, the terminal busbar 264 is secured to the post 262 using a fastener, such as a threaded fastener. The terminal busbar 264 may be secured to the post 262 by a compression connection. In other embodiments, the terminal busbar 264 may be integral with the mounting portion 250 of the charging terminal 240 rather than being a separate and discrete component coupled thereto. The terminal busbar 264 is configured to be electrically connected to the power cable 222. For example, the power cable 222 may be welded to a pad 266 of the terminal busbar 264. In alternative embodiments, the terminal busbar 264 may be crimped to the power cable 222 or secured to the power cable 222 using a bolt connection.

The mating portion 270 extends forward from the mounting portion 250. In an exemplary embodiment, the mating portion 270 includes a pin 272 extending to a distal end 274. The pin 272 is cylindrical. The pin 272 has an outer surface 276 configured to engage the charging socket of the charging plug. In an exemplary embodiment, at least a portion of the pin 272 is hollow. For example, the pin 272 includes a threaded bore 280 at the distal end 274. The threaded bore 280 includes internal threads 282.

In an exemplary embodiment, the charging terminal 240 includes a terminal cap 300 threadably coupled to the distal end 274 of the pin 272. The terminal cap 300 is coupled to the distal end 274 by rotating the terminal cap 300 in a tightening direction. The terminal cap 300 is manufactured from a dielectric material. The terminal cap 300 covers the distal end 274 of the pin 272. The terminal cap 300 is a finger protection cap used to prevent touching of the pin 272. The terminal cap 300 is removable from the pin 272 by rotating the terminal cap 300 in an untightening or loosening direction.

In an exemplary embodiment, the terminal cap 300 is manufactured from a plastic material. For example, the terminal cap 300 may be a molded part. The material may be a polyethylene plastic in various embodiments. In various embodiments, the plastic material may be a high temperature plastic material to avoid melting due to electrical arcing. For example, the material may be a Polytetrafluoroethylene (PTFE) plastic having a melt temperature above 300° C. Optionally, the material may include ceramic fillers to increase the melt temperature of the part. In other embodiments, the terminal cap 300 is manufactured from a ceramic material and has a high melt temperature. The ceramic material may have a melt temperature above 2000° C. The high melt temperature avoids damage or melting due to electrical arcing between the charging terminals.

In an exemplary embodiment, the terminal cap 300 includes a tip 310 and a threaded shaft 312 extending from the tip 310. The tip 310 includes a head 314 of the terminal cap 300. An end of the head 314 may be tapered, such as to guide mating with the socket terminal of the charging plug. In an exemplary embodiment, the head 314 includes a drive element 316 configured to be engaged by a tool to rotate the terminal cap 300 to tighten or loosen the terminal cap 300 relative to the pin 272. In the illustrated embodiment, the drive element 316 is a hex opening configured to receive a hex drive tool. Other types of drive elements may be used in alternative embodiments. The threaded shaft 312 includes threads 318 along the threaded shaft 312. The threads 318 are configured to engage the threads 282 of the threaded bore 280 to secure the terminal cap 300 to the pin 272.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the invention without departing from its scope. Dimensions, types of materials, orientations of the various components, and the number and positions of the various components described herein are intended to define parameters of certain embodiments, and are by no means limiting and are merely exemplary embodiments. Many other embodiments and modifications within the spirit and scope of the claims will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. § 112 (f), unless and until such claim limitations expressly use the phrase “means for” followed by a statement of function void of further structure.

What is claimed is:

1. A charging inlet assembly comprising:
a charging inlet housing having a front and a rear, the charging inlet housing having terminal channels between the front and the rear;
charging terminals received in the corresponding terminal channels and held in the charging inlet housing, the charging terminals having mating ends and terminating ends, the terminating ends configured to be electrically coupled to corresponding power cables, the mating ends including pins configured to be connected to a charging plug, the pins extending to distal ends; and
terminal caps coupled to the corresponding pins, the terminal caps being manufactured from a dielectric material, the terminal caps being threadably coupled to the distal ends.

2. The charging inlet assembly of claim 1, wherein the distal ends have threaded bores, the terminal caps being threadably coupled to the threaded bores.

3. The charging inlet assembly of claim 1, wherein each terminal cap includes a tip and a threaded shaft extending from the tip, the threaded shaft being threadably coupled to the corresponding pin.

4. The charging inlet assembly of claim 1, wherein each terminal cap is manufactured from a plastic material.

5. The charging inlet assembly of claim 1, wherein each terminal cap is manufactured from a ceramic material.

6. The charging inlet assembly of claim 1, wherein each terminal cap is manufactured from a dielectric material capable of withstanding electrical arcing.

7. The charging inlet assembly of claim 1, wherein each terminal cap includes a drive element configured to be engaged by a tool used to rotate the terminal cap to threadably couple the terminal cap to the pin.

8. The charging inlet assembly of claim 1, wherein the terminal cap includes a forward portion forward of the distal end and a rearward portion rearward of the distal end.

9. The charging inlet assembly of claim 1, wherein the terminal cap includes an external portion outside of the pin and an internal portion inside pin.

10. A charging terminal for a charging inlet assembly, the charging terminal comprising:
a terminal body extending between a front and a rear, the terminal body including a mounting portion configured to be secured in a terminal channel of the charging inlet assembly;
a terminating portion at the rear, the terminating portion configured to be terminated to a power cable;
a mating portion at the front, the mating portion including a pin configured to be connected to a charging socket of a charging plug, the pin having a distal end; and
a terminal cap threadably coupled to the distal end of the pin, the terminal cap being manufactured from a dielectric material.

11. The charging terminal of claim 10, wherein the distal end includes a threaded bore, the terminal cap being threadably coupled to the threaded bore.

12. The charging terminal of claim 10, wherein the terminal cap includes a tip and a threaded shaft extending from the tip, the threaded shaft being threadably coupled to the pin.

13. The charging terminal of claim 10, wherein the terminal cap is manufactured from a plastic material.

14. The charging terminal of claim 10, wherein the terminal cap is manufactured from a ceramic material.

15. The charging terminal of claim 10, wherein the terminal cap is manufactured from a dielectric material capable of withstanding electrical arcing.

16. The charging terminal of claim 10, wherein the terminal cap includes a drive element configured to be engaged by a tool used to rotate the terminal cap to threadably couple the terminal cap to the pin.

17. The charging terminal of claim 10, wherein the terminal cap includes a forward portion forward of the distal end and a rearward portion rearward of the distal end.

18. The charging terminal of claim 10, wherein the terminal cap includes an external portion outside of the pin and an internal portion inside pin.

19. A charging terminal for a charging inlet assembly, the charging terminal comprising:
a terminal body extending between a front and a rear, the terminal body including a mounting portion configured to be secured in a terminal channel of the charging inlet assembly;
a terminating portion at the rear, the terminating portion configured to be terminated to a power cable;
a mating portion at the front, the mating portion including a pin configured to be connected to a charging socket of a charging plug, the pin having a distal end, the pin having a threaded bore open at the distal end; and
a terminal cap coupled to the pin, the terminal cap being manufactured from a dielectric material, the terminal cap including a tip and a threaded shaft extending from the tip, the threaded shaft being threadably coupled to the threaded bore, the tip located forward of the distal end.

20. The charging terminal of claim 19, wherein the terminal cap is manufactured from a ceramic material.
